(19) United States
(12) Patent Application Publication
(10) Pub. No.: US 2021/0401224 A1
(43) Pub. Date: Dec. 30, 2021

(54) INFORMATION PROCESSING DEVICE, INFORMATION PROCESSING METHOD, AND PROGRAM

(71) Applicant: SONY CORPORATION, TOKYO (JP)

(72) Inventors: TAKUYA KOMAMI, KANAGAWA (JP); KAZUO HONGO, TOKYO (JP); MASAYA KINOSHITA, TOKYO (JP)

(21) Appl. No.: 17/281,236

(22) PCT Filed: Aug. 22, 2019
(86) PCT No.: PCT/JP2019/032739

§ 371 Date: Mar. 29, 2021

(30) Foreign Application Priority Data
Oct. 9, 2018 (JP) 2018-191248

(51) Int. Cl. A47J 36/32; B25J 11/00; B25J 13/08; A47J 37/04

(52) U.S. Cl. CPC A47J 36/32; A47J 37/04; B25J 13/085; B25J 11/0045

(57) ABSTRACT

An information processing device 10 includes a determination unit 13 that determines a force to be applied to a food material during cooking by a pressing portion on the basis of food material information regarding elasticity of the food material before cooking, and an estimation unit 14 that estimates progress of cooking of the food material on the basis of information regarding deformation of the food material when the pressing portion has applied the force to the food material during the cooking.

### FIELD

The present disclosure relates to an information processing device, an information processing method, and a program.

### BACKGROUND

Some cookers, robots, and the like perform automatic cooking. Patent Literature 1 discloses an automatic cooker that stops heating if a weight loss rate from the start of cooking of an object to be cooked reaches a set weight loss rate.

### CITATION LIST

### Patent Literature

Patent Literature 1: JP H3-272717 A

### SUMMARY

### Technical Problem

However, in the prior art described above, cooking has been performed by guessing a finish from the weight loss rate on the assumption that a baked degree of the object to be cooked at a certain level of heating power and a weight loss rate from the start of the cooking are almost constant for each type of material. However, in the prior art, even though types of food materials are the same as each other, if shapes, thicknesses, parts, and the like, of the food materials are different from each other, the finishes have become different. For this reason, depending on the food materials, a cook or the like should make sure of the finish of cooking.

Therefore, the present disclosure proposes an information processing device, an information processing method, and a program capable of improving estimation accuracy of the progress of cooking of a food material.

### Solution to Problem

To solve the problem described above, an information processing device is provided that includes: a determination unit that determines a force to be applied to a food material during cooking by a pressing portion on the basis of food material information regarding elasticity of the food material before cooking; and an estimation unit that estimates progress of cooking of the food material on the basis of information regarding deformation of the food material when the pressing portion has applied the force to the food material during the cooking.

Moreover, an information processing method executed by a computer is provided that includes: determining a force to be applied to a food material during cooking by a pressing portion on the basis of food material information regarding elasticity of the food material before cooking; and estimating progress of cooking of the food material on the basis of information regarding deformation of the food material when the pressing portion has applied the force to the food material during the cooking.

Moreover, a program is provided that causes a computer to execute: a step of determining a force to be applied to a food material during cooking by a pressing portion on the basis of food material information regarding elasticity of the food material before cooking; and a step of estimating progress of cooking of the food material on the basis of information regarding deformation of the food material when the pressing portion has applied the force to the food material during the cooking.

### BRIEF DESCRIPTION OF DRAWINGS

FIG. 1 is a perspective view illustrating an example of an appearance of a robot according to a first embodiment of the present disclosure.

FIG. 2 is a diagram illustrating a configuration example of an information processing device according to the first embodiment.

FIG. 3 is a diagram illustrating an example of measurement of a food material before cooking according to the first embodiment.

FIG. 4 is a diagram illustrating an example of measurement of the food material during cooking according to the first embodiment.

FIG. 5 is a diagram illustrating an example of the relationship between a thickness of the food material before cooking and a target deformation amount.

FIG. 6 is a flowchart illustrating an example of a processing procedure executed by the information processing device according to the first embodiment.

FIG. 7 is a diagram illustrating a relationship among a temperature of a target part of meat, a change in the target part, and sterilization.

FIG. 8 is a flowchart illustrating an example of a processing procedure executed by the information processing device according to a modification of the first embodiment.

FIG. 9 is a diagram illustrating a configuration example of an information processing device according to a second embodiment.

FIG. 10 is a flowchart illustrating an example of a processing procedure executed by the information processing device according to the second embodiment.

FIG. 11 is a flowchart illustrating an example of a processing procedure of baked color processing executed by the information processing device according to the second embodiment.

FIG. 12 is a hardware configuration diagram illustrating an example of a computer that realizes a function of an information processing device.

### DESCRIPTION OF EMBODIMENTS

Hereinafter, embodiments of the present disclosure will be described in detail with reference to the drawings. Note that in each of the following embodiments, the same portions will be denoted by the same reference numerals and an overlapping description thereof will be omitted.

### First Embodiment

[Outline of Information Processing Device According to First Embodiment]

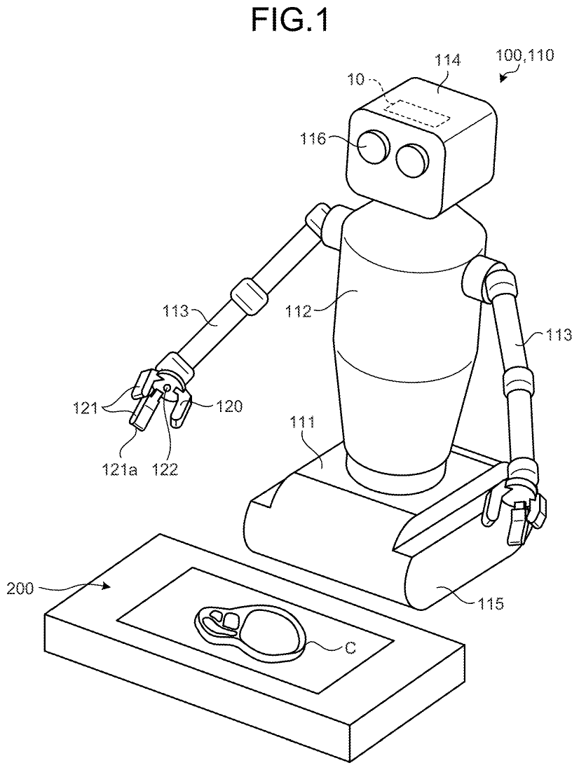

FIG. 1 is a perspective view illustrating an example of an appearance of a robot according to a first embodiment of the present disclosure. As illustrated in FIG. 1, the robot 100 is, for example, a two-armed robot that imitates a humanoid, and is a robot that performs cooking in a home, a restaurant, or the like. The robot 100 includes a robot main body 110. The robot main body 110 includes a base portion 111 as a base, a body portion 112 supported on the base portion 111, an arm 113 provided on the body portion 112, a head portion 114 provided above the body portion 112, and a moving mechanism 115 beneath the base portion 111.

The head portion 114 is provided with an image capturing unit 116 that capturing an image a front of the robot main body 110. Hereinafter, in the robot main body 110, a surface on which the image capturing unit 116 is provided will be referred to as a front surface, a surface opposing the surface on which the image capturing unit 116 is provided will be referred to as a rear surface, and surfaces that are sandwiched between the front surface and the rear surface and are in a direction that is not a vertical direction will be referred to as side surfaces. As the image capturing unit 116, an optical camera or the like can be exemplified. The image capturing unit 116 can be used for visually deciding a food material C cooked by the robot 100. The food material C includes, for example, meat, fish, vegetables, and the like. The meat includes, for example, beef, pork, and chicken. In the present embodiment, a case where the food material C is beef will be described.

The arm 113 is provided on the body portion 112. The number of arms 113 is arbitrary. In the example of FIG. 1, a case where two arms 113 are symmetrically provided on two side surfaces of the body portion 112 opposing each other is illustrated. The arm 113 is, for example, a 7-degree-of-freedom arm. A tip of the arm 113 is provided with a hand 120 capable of gripping a gripped object, which is a target object. The hand 120 is made of a metal material, a resin material, or the like. The moving mechanism 115 is a means for moving the robot main body 110, and includes wheels, legs, or the like.

In the present embodiment, the hand 120 of the robot 100 has a plurality of fingers 121 and a position grasping unit 122. A tip of each finger 121 is provided with a pressure detection unit 121a for detecting a pressure of a contact object. The pressure detection unit 121a is, for example, a capacitance change-type, electric resistance change-type, or electromagnetic induction-type force-tactile sensor. The hand 120 has a configuration in which the food material can be pinched and pressed by the plurality of fingers 121. In the present embodiment, the finger 121 of the robot 100 is an example of a pressing portion. The robot 100 has, for example, a function of controlling the drive of the arm 113, the hand 120, the moving mechanism 115, and the like, to perform cooking.

The position grasping unit 122 is provided in the vicinity of the center of the palm of the hand 120. The position grasping unit 122 grasps an exact position of the gripped object gripped with the hand 120 or the object pressed with the finger 121. The position grasping unit 122 includes, for example, an image capturing device that captures an image of an object, a distance sensor that measures a distance to the object, and the like.

[Configuration of Information Processing Device According to First Embodiment]

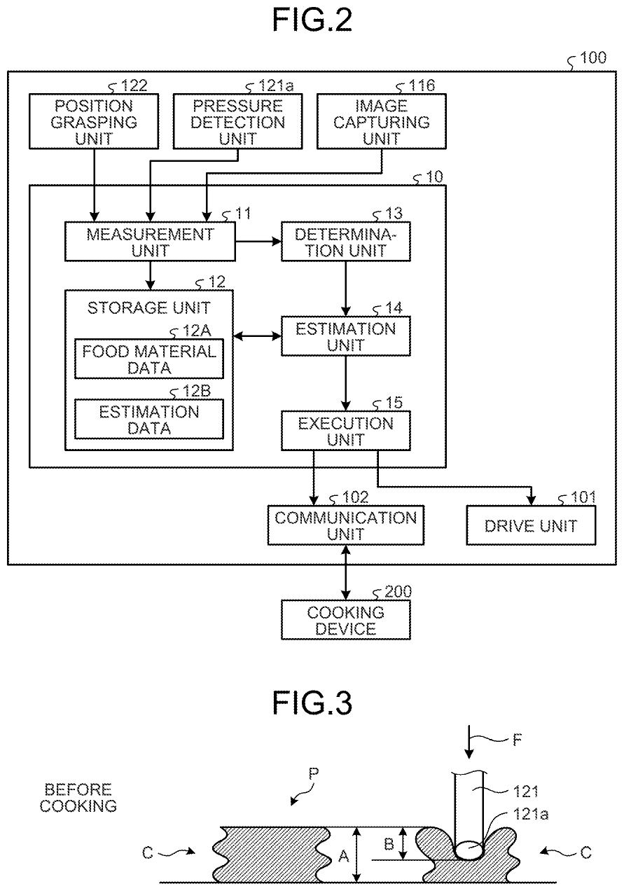

FIG. 2 is a diagram illustrating a configuration example of an information processing device 10 according to the first embodiment. As illustrated in FIG. 2, the robot 100 includes an information processing device 10, a drive unit 101, and a communication unit 102. The information processing device 10 is, for example, a dedicated or general-purpose computer. The information processing device 10 has a function of controlling some operations or the like of the robot 100. The drive unit 101 drives each drivable part of the robot 100. The communication unit 102 has a function of performing communication of information with a cooking device 200, an information processing server, and the like via a network. The communication unit 102 transmits a control signal or the like from the information processing device 10 or the like to the cooking device 200. The cooking device 200 includes, for example, a stove, a grill, an oven, and the like.

The information processing device 10 includes a measurement unit 11, a storage unit 12, a determination unit 13, an estimation unit 14, and an execution unit 15. In the present embodiment, each processing unit of the measurement unit 11, the determination unit 13, the estimation unit 14, and the execution unit 15 is realized by executing a program stored in the information processing device 10 using a random access memory (RAM) or the like as a work area by, for example, a central processing unit (CPU), a micro control unit (MCU), or the like. In addition, each processing unit may be realized by, for example, an integrated circuit such as an application specific integrated circuit (ASIC), a field programmable gate array (FPGA), or the like.

The measurement unit 11 measures a thickness of the food material C. The measurement unit 11 is electrically connected to the image capturing unit 116, the pressure detection unit 121a, the position grasping unit 122, the storage unit 12, and the determination unit 13 of the robot 100. The measurement unit 11 measures, for example, the thickness of the food material on the basis of an analysis result of an image captured by the image capturing unit 116. The measurement unit 11 measures the thickness of the food material C on the basis of, for example, a position where the pressure detection unit 121a of the finger 121 of the robot 100 has come into contact with the food material C. For example, the measurement unit 11 measures the thickness of the food material C on the basis of a distance between the fingers 121 when the food material C is sandwiched between the fingers 121 of the robot 100. The measurement unit 11 outputs measurement results of the thickness of the food material C before and during cooking to the determination unit 13.

The storage unit 12 stores various data. For example, the storage unit 12 can store the measurement result of the measurement unit 11. The storage unit 12 is electrically connected to the estimation unit 14 and the like. The storage unit 12 stores food material data 12A, estimation data 12B, and the like. The food material data 12A includes, for example, food material information regarding elasticity of the food material C. The food material information includes, for example, information indicating a thickness, an image, and the like of the food material C before cooking. The estimation data 12B includes, for example, information for estimating the progress of cooking of the food material C. The estimation data 12B may include information for estimating the progress of cooking of a plurality of types of food materials.

The storage unit 12 is, for example, a semiconductor memory element such as a RAM, a flash memory, or the like, a hard disk, an optical disk, or the like. Note that the storage unit 12 may be provided in the robot 100. Specifically, the storage unit 12 may be provided in a cloud server connected to the information processing device 10 via a network.

The determination unit 13 determines a force to be applied to the food material C during cooking by the finger 121 (pressing portion) of the robot 100, on the basis of the food material information regarding the elasticity of the food material C before cooking. In the present embodiment, the food material information regarding the elasticity of the food material C includes, for example, information such as hardness of the food material C, a deformation amount of the food material C when a force has been applied to the food material C, a force to be applied, and the like. The food material information may include, for example, information indicating a distribution state of fat or the like of the food material C. The determination unit 13 may determine a force that deforms the food material C to a target deformation amount according to the thickness of the food material C as the force to be applied. The determination unit 13 may determine a force to be applied to the food material during cooking on the basis of a force that has deformed the food material C before cooking to the target deformation amount with the finger 121 of the robot 100. The determination unit 13 may determine the force to be applied to the food material C during cooking on the basis of food material information of a plurality of different spots in the food material C before cooking.

FIG. 3 is a diagram illustrating an example of measurement of the food material before cooking according to the first embodiment. As illustrated in FIG. 3, the determination unit 13 measures, for example, a thickness of the food material C before cooking at random multi-point measurement points P of the food material C to obtain an average thickness A of the food material C before cooking. Then, the determination unit 13 determines a force F to be applied to the food material C during cooking by the finger 121 of the robot 100 on the basis of the thickness of the food material C before cooking. Note that the determination unit 13 may obtain the thickness A at one or a plurality of preset measurement points of the food material C, such as the vicinity of the center, a lean portion, and the like, of the food material C. For example, it is assumed that a target deformation amount B of the food material C is 0.8 cm in a case where the thickness A of the food material C before cooking is 1 cm. In this case, the determination unit 13 illustrated in FIG. 2 confirms the force F that presses the finger 121 of the robot 100 until the thickness of the food material C becomes a thickness of the food material C corresponding to the target deformation amount B on the basis of a detection result of the pressure detection unit 121a, and determines the force F as the force to be applied. Therefore, the determination unit 13 can determine the force F suitable for a peculiar thickness, hardness, material, or the like, of the food material C to be cooked. In addition, a method of pressing the finger 121 of the robot 100 may be, for example, a method of pressing the force F from a plurality of directions such as pinching and sandwiching with the fingers 121 of the robot 100, in addition to a method of pressing the force F from above in a vertical direction on a surface of a plate, a table, a net, or the like. Note that an example of a relationship between the thickness A of the food material C before cooking and the target deformation amount B will be described later. The determination unit 13 outputs a determined result to the estimation unit 14.

The estimation unit 14 estimates the progress of the cooking of the food material C on the basis of information regarding deformation of the food material C when the finger 121 of the robot 100 has applied the force to the food material C during cooking. The estimation unit 14 estimates that the cooking of the food material has been completed in a case where the deformation amount of the food material C during cooking has become the target deformation amount. The estimation unit 14 changes the target deformation amount on the basis of the thickness of the food material C during cooking, measured by the measurement unit 11, and estimates that the cooking of the food material C has been completed in a case where the deformation amount of the food material C during cooking has become the target deformation amount after the change. The estimation unit 14 stores an estimation result in the storage unit 12, and outputs the estimation result to the execution unit 15.

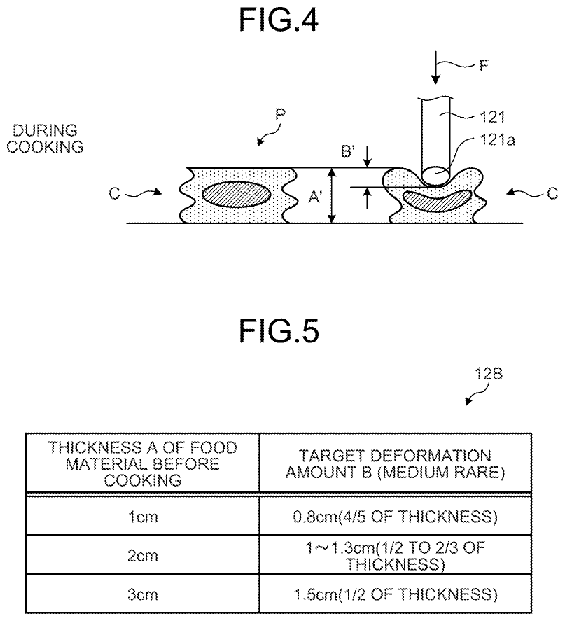

FIG. 4 is a diagram illustrating an example of measurement of the food material during cooking according to the first embodiment. As illustrated in FIG. 4, the estimation unit 14 causes the finger 121 of the robot 100 to apply the force F determined by the determination unit 13 to the measurement point P of the food material C during cooking, for example, after starting the cooking of the food material C. The estimation unit 14 obtains a deformation amount B′ from a thickness of the food material C at the measurement point P. In addition, in a case where the food material C is beef or the like, the thickness A of the food material C is reduced when the food material C is baked by the cooking. For this reason, the estimation unit 14 measures the thickness of the food material C during cooking at the measurement point P in a state where a force is not applied to the food material C during cooking with the finger 121 of the robot 100 to obtain an average thickness A′ of the food material C during cooking. Then, the estimation unit 14 estimates the progress of the cooking of the food material C on the basis of the thickness A′ of the food material C during cooking and the deformation amount B′. For example, the estimation unit 14 estimates a degree of completion of the cooking of food material C, an evaluation of the food material C during cooking, and the like, as the progress of the cooking. In other words, the estimation unit 14 estimates a temperature state, a degree of baking, and the like, inside the food material C which are difficult to decide from a surface of the food material C during cooking. For example, the estimation unit 14 makes an estimation according to a type of baking method of the food material C. The type of baking method includes, for example, rare, medium rare, medium, medium well, well, well-done, very well-done, and the like.

For example, in a case where the baking method in the cooking of the food material C is medium rare, the estimation unit 14 estimates that the cooking of the food material C has been completed if the deformation amount B′ when the food material C during cooking has been pressed with the force F is ⅓ of the thickness A′. Then, the estimation unit 14 estimates that the cooking of the food material C has not been completed if the deformation amount B′ when the food material C during cooking has been pressed with the force F is larger than ⅓ of the thickness A′. The estimation unit 14 may obtain a degree of completion of the cooking on the basis of, for example, the deformation amount B′.

A case where the information processing device 10 measures the thickness of the food material C before cooking at the random multi-point measurement points P of the food material C is described in the present embodiment, but the present disclosure is not limited thereto. The information processing device 10 may estimate the progress of the cooking of the food material C at the same measurement point P of the food material C. For example, in a case where the information processing device 10 measures the food material C at the same measurement point P, the information processing device 10 may evaluate a degree of change by individual forces F based on individual thicknesses or an average of forces F based on individual thicknesses to estimate the progress of the cooking of the food material C.

Returning to FIG. 2, the execution unit 15 executes processing based on the estimation result of the estimation unit 14. The processing based on the estimation result includes, for example, processing for controlling the cooking device 200 according to the estimation result, processing for controlling an operation regarding the cooking of the robot 100 according to the estimation result, and the like. For example, the execution unit 15 executes processing by executing a program. For example, in a case where the estimation result is the completion of the cooking, the execution unit 15 executes processing for requesting the cooking device 200 to finish heating via the communication unit 102. For example, in a case where the estimation result is the completion of the cooking, the execution unit 15 executes processing for causing the drive unit 101 of the robot 100 to move the food material C from the cooking device 200 to dish up the food material C. For example, in a case where the estimation result is the incompletion of the cooking, the execution unit 15 executes processing for requesting the cooking device 200 to adjust a degree of heating via the communication unit 102. For example, in a case where the estimation result is the incompletion of the cooking, the execution unit 15 executes processing for controlling the drive unit 101 to cause the robot 100 to perform an operation such as pinching and turning over the food material C.

An example of a relationship between the thickness A of the food material C before cooking and the target deformation amount B will be described. FIG. 5 is a diagram illustrating an example of a relationship between the thickness A of the food material C before cooking and the target deformation amount B. As illustrated in FIG. 5, the estimation data 12B has estimation information indicating the relationship between the thickness A of the food material C before cooking and the target deformation amount B. The estimation information is associated with a type and a baking method of the food material C. The estimation data 12B is set on the basis of, for example, an experimental result, an analysis result, deep learning, and the like.

In the example illustrated in FIG. 5, the estimation data 12B shows a case where the food material C is beef and the baking method is medium rare. The estimation data 12B shows that in a case where the thickness A of the food material C before cooking is 1 cm, the target deformation amount B is 0.8 cm (⅘ of the thickness A). The estimation data 12B shows that in a case where the thickness A of the food material C before cooking is 2 cm, the target deformation amount B is 1 to 1.3 cm (½ to ⅔ of the thickness A). The estimation data 12B shows that in a case where the thickness A of the food material C before cooking is 3 cm, the target deformation amount B is 1.5 cm (½ of the thickness A). If the thickness A of the food material C is measured, the determination unit 13 sets the target deformation amount B on the basis of estimation information of the estimation data 12B corresponding to the thickness A.

The functional configuration example of the information processing device 10 according to the present embodiment has been described hereinabove. Note that the configuration described above with reference to FIG. 2 is merely an example, and a functional configuration of the information processing device 10 according to the present embodiment is not limited to such an example. The functional configuration of the information processing device 10 according to the present embodiment can be flexibly modified according to specifications or operations.

[Processing Procedure of Information Processing Device 10 According to First Embodiment]

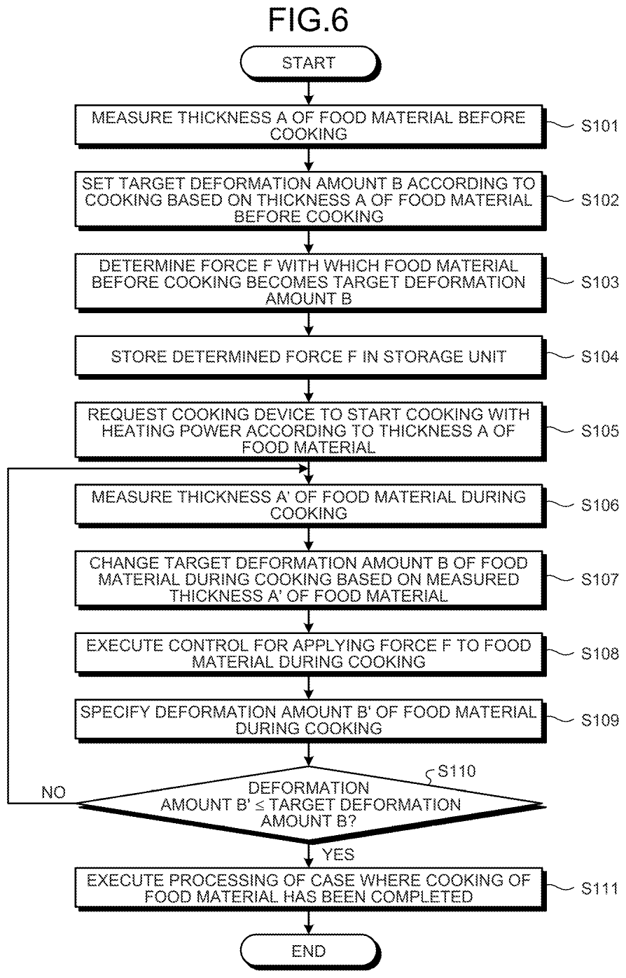

Next, an example of a processing procedure of the information processing device 10 according to the first embodiment will be described. FIG. 6 is a flowchart illustrating an example of a processing procedure executed by the information processing device 10 according to the first embodiment. The processing procedure illustrated in FIG. 6 is realized by the information processing device 10 executing a program. The processing procedure illustrated in FIG. 6 is repeatedly executed by the information processing device 10.

As illustrated in FIG. 6, the information processing device 10 measures the thickness A of the food material C before cooking (Step S101). For example, the information processing device 10 measures the thickness A of the food material C by a measuring method of the measurement unit 11. The information processing device 10 realizes the measurement unit 11 by executing Step S101. If the processing of Step S101 ends, the information processing device 10 advances the processing to Step S102.

The information processing device 10 sets the target deformation amount B according to the cooking on the basis of the thickness A of the food material C before cooking (Step S102). For example, the information processing device 10 extracts and sets the target deformation amount B corresponding to the thickness A from the estimation data 12B of the storage unit 12. If the information processing device 10 sets the target deformation amount B, the information processing device 10 advances the processing to Step S103.

The information processing device 10 determines the force F with which the food material C before cooking becomes the target deformation amount B (Step S103). For example, the information processing device 10 presses the food material C with the finger 121 of the robot 100 through the drive unit 101 until the thickness of the food material C becomes a thickness of the food material C corresponding to the target deformation amount B. Then, the information processing device 10 detects the force F with which the finger 121 of the robot 100 presses the food material C when the thickness of the food material C has become the thickness of the food material C corresponding to the target deformation amount B, by the pressure detection unit 121a, and determines the force F as the force to be applied. A series of processing from Step S102 to Step S103 corresponds to a processing procedure of the determination unit 13. If the information processing device 10 determines the force F, the information processing device 10 advances the processing to Step S104.

If the information processing device 10 stores the determined force F in the storage unit 12 (Step S104), the information processing device 10 advances the processing to Step S105. The information processing device 10 requests the cooking device 200 to start cooking with heating power according to the thickness A of the food material C (Step S105). For example, the information processing device 10 requests the cooking device 200 to start the cooking via the communication unit 102. Note that the information processing device 10 may control an operation of the robot 100 to start the cooking. If the information processing device 10 causes the cooking device 200 to start the cooking, the information processing device 10 advances the processing to Step S106.

The information processing device 10 measures the thickness A′ of the food material C during cooking (Step S106). For example, the information processing device 10 measures the thickness A′ of the food material C by the abovementioned measuring method of the measurement unit 11. The information processing device 10 realizes the measurement unit 11 by executing Step S106. If the processing of Step S106 ends, the information processing device 10 advances the processing to Step S107.

The information processing device 10 changes the target deformation amount B of the food material C during cooking on the basis of the measured thickness A′ of the food material C (Step S107). For example, the information processing device 10 compares the measured thickness A′ of the food material C with the thickness A before cooking to obtain a shrinkage rate, and changes the target deformation amount B by the shrinkage rate. That is, the information processing device 10 reflects an amount of shrinkage caused by heating the food material C in the target deformation amount B. Note that the information processing device 10 does not change the target deformation amount B in a case where the food material C does not shrink even though heated. If the processing of Step S107 ends, the information processing device 10 advances the processing to Step S108.

The information processing device 10 executes control for applying the force F to the food material C during cooking (Step S108). For example, the information processing device 10 controls the drive unit 101 so that the finger 121 of the robot 100 presses the measurement point P of the food material C during cooking with the force F. As a result, the tip of the finger 121 of the robot 100 presses the measurement point P of the food material C during cooking with the force F. If the processing of Step S108 ends, the information processing device 10 advances the processing to Step S109.

The information processing device 10 specifies the deformation amount B′ of the food material C during cooking (Step S109). For example, the information processing device 10 specifies the deformation amount B′ on the basis of a measurement result of the thickness and the thickness A′ of the food material C at the measurement point P. If the information processing device 10 stores the specified deformation amount B′ in the storage unit 12, the information processing device 10 advances the processing to Step S110.

The information processing device 10 determines whether or not the deformation amount B′ is equal to or less than the target deformation amount B (Step S110). In a case where the information processing device 10 has determined that the deformation amount B′ is not equal to or less than the target deformation amount B (Step S110: No), the information processing device 10 returns the processing to Step S106 described above. Alternatively, in a case where the information processing device 10 has determined that the deformation amount B′ is equal to or less than the target deformation amount B (Step S110: Yes), the information processing device 10 advances the processing to Step S111. Note that a series of processing from Step S106 to Step S110 corresponds to a processing procedure of the estimation unit 14.

The information processing device 10 executes processing of a case where the cooking of the food material C has been completed (Step S111). For example, the information processing device 10 executes the processing for requesting the cooking device 200 to finish heating via the communication unit 102. For example, the information processing device 10 executes the processing for causing the drive unit 101 of the robot 100 to move the food material C from the cooking device 200 to dish up the food material C. The processing of Step S111 corresponds to the processing of the execution unit 15. If the processing of Step S111 ends, the information processing device 10 ends the processing procedure illustrated in FIG. 6.

As described above, the information processing device 10 according to the first embodiment determines the force to be applied by the finger 121 of the robot 100 to the food material C during cooking on the basis of the food material information of the food material C before cooking. The information processing device 10 estimates the progress of the cooking on the basis of the information regarding the deformation of the food material C when the finger 121 has applied the force to the food material C during cooking. Therefore, the information processing device 10 can determine the force to be applied to the food material during cooking on the basis of the elasticity of the food material C before cooking and estimate the progress of the cooking on the basis of a result of actually pressing the food material during cooking. For example, in a case where the food material C is beef, even though parts of the beef are the same as each other, the parts may not be finished in the same manner in the same cooking time depending on a distribution situation of fat, tendon, or the like. For this reason, it is difficult to guess a state inside the food material C from a visual element during cooking. Therefore, it is conceivable to measure an internal temperature of the food material C during cooking, but in that case, a temperature measuring member or the like is inserted into the food material C during cooking and a hole is thus made in the food material C, and juice comes out from the hole. The information processing device 10 according to the present disclosure can improve estimation accuracy of the progress of the cooking of the food material C without damaging the food material C even though states of the food material are different from each other. In addition, the information processing device 10 can improve accuracy of the progress during cooking in cooking that cooks the food material C.

In addition, the information processing device 10 determines the force F that deforms the food material C to the target deformation amount B according to the thickness of the food material C before cooking, and estimates the progress of the cooking on the basis of the deformation amount B′ when the force F has been applied to the food material C during cooking and the target deformation amount B. Therefore, the information processing device 10 can estimate the progress of the cooking on the basis of the deformation amounts of the food material C before and during cooking. As a result, the information processing device 10 can improve the estimation accuracy of the progress of the cooking of the food material C even though the elasticity of the food material C changes in accordance with the progress of the cooking.

In addition, the information processing device 10 changes the target deformation amount on the basis of the thickness of the food material C measured during cooking, and estimates that the cooking of the food material C has been completed in a case where the deformation amount B′ of the food material C during cooking has become the target deformation amount B after the change. Therefore, the information processing device 10 can estimate the progress of the cooking on the basis of the target deformation amount that has considered the shrinkage amount even though the food material C shrinks during cooking. As a result, the information processing device 10 can improve the estimation accuracy of the progress of the cooking of the food material C even through the food material C shrinks during cooking.

In addition, the information processing device 10 determines the force F to be applied to the food material C during cooking on the basis of the force with which the finger 121 of the robot 100 has deformed the food material C before cooking to the target deformation amount B. Therefore, the information processing device 10 can press the food material C during cooking with the force F corresponding to the elasticity of the food material C before cooking. As a result, the information processing device 10 can improve the estimation accuracy of the progress of the cooking of the food material C even through the elasticity of the food material C before cooking is different.

In addition, the information processing device 10 determines the force F to be applied to the food material C during cooking on the basis of the thickness A of a plurality of different measurement points in the food material C before cooking. Therefore, the information processing device 10 can grasp a distribution of the thickness of the food material C before cooking to determine the force F to be applied to the food material C during cooking. For example, in a case where the food material C is beef or the like, the processed food material C may not have a uniform thickness. The information processing device 10 can obtain the distribution of the force F suitable for the food material C before cooking by determining the force F based on the distribution of the thickness of the food material C. As a result, the information processing device 10 can improve the estimation accuracy of the progress of the cooking of the food material C by considering the distribution of the thickness of the food material C before cooking.

In addition, the information processing device 10 executes processing based on the estimation result of the progress of the cooking of the food material C. In other words, the information processing device 10 executes the processing with an estimation that the thickness of the food material C has become a thickness of completion, such that the cooking has been completed, as a trigger. Therefore, the information processing device 10 can execute the process for requesting the cooking device 200 to finish the heating, for example, when it has estimated that the cooking of the food material C has been completed. For example, the information processing device 10 can execute, for example, the processing for causing the drive unit 101 of the robot 100 to move the food material C from the cooking device 200 to dish up the food material C. As a result, the information processing device 10 can execute the processing according to the estimation result of the progress of the cooking of the food material C, and can thus expand range of an application to machine cooking.

In addition, the information processing device 10 determines the force F with which the food material C during cooking is pressed with the finger 121 of the robot 100. Therefore, the information processing device 10 can press the food material C during cooking with the finger 121 of the robot 100. As a result, in the information processing device 10, the robot 100 presses the food material C during cooking, and thus, it is not necessary for a person to touch the food material C during cooking.

A case where the information processing device 10 presses the food material C with the finger 121 of the robot 100 has been described in the first embodiment described above, but the present disclosure is not limited thereto. For example, the information processing device 10 may use a member having a pointed tip, a member having a rounded tip, a member having an angular tip, or the like as a member that presses the food material C. For example, the information processing device 10 may use a member having one or a plurality of tips, a linear shape, a net shape, a planar shape, or the like.

The first embodiment described above is an example, and various modifications and applications can be made.

[Modification of First Embodiment]

For example, the information processing device 10 according to the first embodiment can estimate the progress during cooking by adding another item to the deformation amount B′ of the food material C.

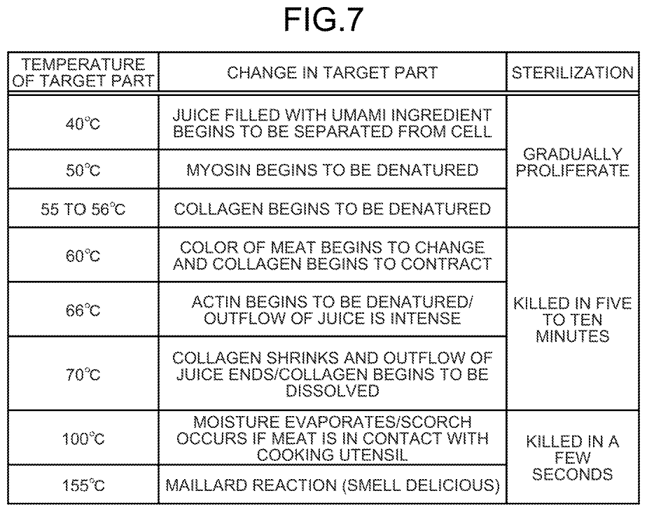

FIG. 7 is a diagram illustrating a relationship among a temperature of a target part of meat, a change in the target part, and sterilization. Note that the target part refers to a target part of meat to be determined, and the change in the target part includes, for example, a change in proteins, and the like. As illustrated in FIG. 7, the meat has a problem in terms of hygiene at 59° C. or less. The meat is heated to a temperature range of 60° C. to 65° C. to be moderately cooked. In the meat, actin begins to be denatured at 66° C., and the outflow of juice becomes intense. Then, low-temperature cooking of the meat is a cooking method of equalizing a temperature in the temperature range over time from the outside. In addition, if a temperature of the meat becomes 66° C. or more, a taste of meat is extremely bad. The meat is scented by partially causing a Maillard reaction in a burnt mark of a surface thereof.

The information processing device 10 according to the modification of the first embodiment uses an amount of juice flowing out from the food material C during cooking to estimate the progress of the cooking. Note that a description for the same configuration as the information processing device 10 according to the first embodiment illustrated in FIG. 2 will be omitted.

The estimation unit 14 estimates the progress of the cooking of the food material C on the basis of an amount of juice accumulated in a dent of the food material C during cooking pressed with the force F by the finger 121 of the robot 100. For example, the estimation unit 14 confirms whether or not the juice is accumulated in the dent of the food material C, an amount of juice based on a size of the dent, and the like, on the basis of an image of a part of the pressed dent captured by the image capturing unit 116. The estimation unit 14 estimates that denaturation of a protein inside the food material C due to a temperature rise is progressing if the juice is accumulated in the dent of the food material C. The estimation unit 14 confirms the amount of juice accumulated in the dent in a state in which the finger 121 of the robot 100 is pressed against the food material C or in a state in which the dent is generated in the food material C in a case where the finger 121 of the robot 100 is separated from the food material C. Then, the estimation unit 14 estimates that the cooking of the food material C has been completed, for example, if the deformation amount B′ of the food material C during cooking becomes the target deformation amount B and the juice is accumulated in the dent of the food material C. In addition, the estimation unit 14 may estimate whether or not the juice is accumulated in the dent of the food material C using, for example, a contact sensor or the like.

[Processing Procedure of Information Processing Device 10 According to Modification of First Embodiment]

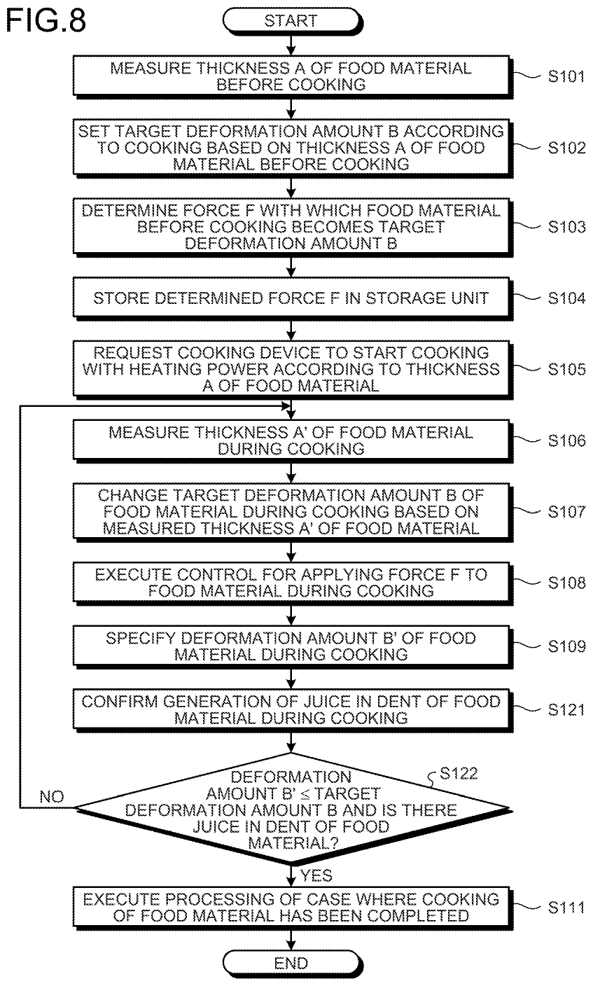

Next, an example of a processing procedure of the information processing device 10 according to the modification of the first embodiment will be described. FIG. 8 is a flowchart illustrating an example of a processing procedure executed by the information processing device 10 according to the modification of the first embodiment. The processing procedure illustrated in FIG. 8 is realized by the information processing device 10 executing a program. The processing procedure illustrated in FIG. 8 is repeatedly executed by the information processing device 10.

In the example illustrated in FIG. 8, Step S101 to Step S109 and Step S111 are the same as Step S101 to Step S109 and Step S111 illustrated in FIG. 6 described above, and thus, only different parts will be described and a description for the same parts will be omitted.

If the information processing device 10 specifies the deformation amount B′ of the food material C during cooking in Step S109, the information processing device 10 confirms the generation of juice in the dent of the food material C during cooking (Step S121). For example, the information processing device 10 confirms whether or not the juice is accumulated in a dent portion of the food material C by the pressing of the finger 121 of the robot 100 on the basis of the image captured by the image capturing unit 116. If the processing of Step S121 ends, the information processing device 10 advances the processing to Step S122.

The information processing device 10 determines whether or not the deformation amount B′ of the food material C during cooking is equal to or less than the target deformation amount B and there is juice in the dent of the food material C (Step S122). In a case where the information processing device 10 has determined that the deformation amount B′ is not equal to or less than the target deformation amount B and there is no juice in the dent of the food material C (Step S122: No), the information processing device 10 returns the processing to Step S106 described above. Alternatively, in a case where the information processing device 10 has determined that the deformation amount B′ is equal to or less than the target deformation amount B and there is juice in the dent of the food material C (Step S122: Yes), the information processing device 10 advances the processing to Step S111 described above. If the information processing device 10 executes processing of a case where the cooking of the food material C has been completed (Step S111), the information processing device 10 ends the processing procedure illustrated in FIG. 8.

As described above, the information processing device 10 according to the modification of the first embodiment estimates the progress of the cooking on the basis of a comparison result between the deformation amount B′ when the force F according to the thickness of the food material C before cooking is applied to the food material C during cooking and the target deformation amount B and a degree of accumulation of the juice in the dent of the food material C. Resultantly, the information processing device 10 can estimate the progress of the cooking on the basis of a state inside the food material C. As a result, the information processing device 10 can improve the estimation accuracy of the progress of the cooking including a degree of baking inside the food material C.

### Second Embodiment

[Outline of Information Processing Device According to Second Embodiment]

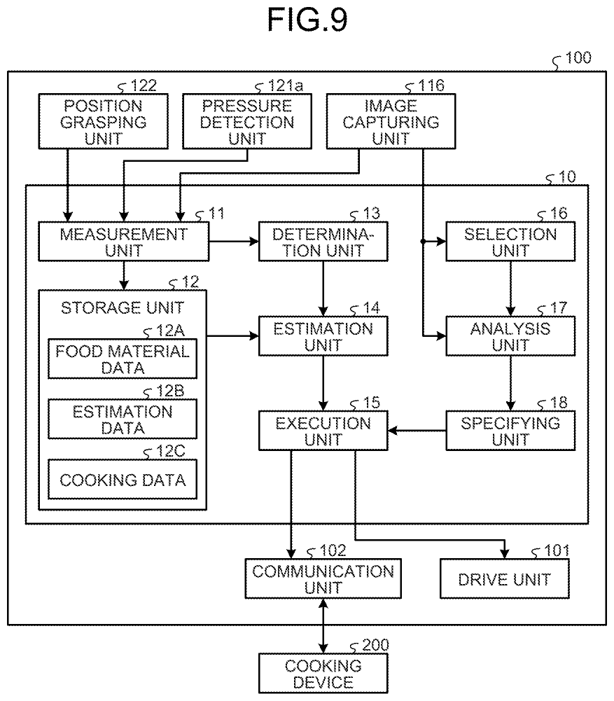

Next, a second embodiment will be described. FIG. 9 is a diagram illustrating a configuration example of an information processing device 10 according to a second embodiment. As illustrated in FIG. 9, the information processing device 10 according to the second embodiment includes a measurement unit 11, a storage unit 12, a determination unit 13, an estimation unit 14, and an execution unit 15, similarly to the first embodiment. The information processing device 10 further includes a selection unit 16, an analysis unit 17, and a specifying unit 18. Note that a description for configurations similar to those of the information processing device 10 according to the first embodiment will be omitted.

The selection unit 16 selects a dishing-up surface of a food material C on the basis of an image of the food material C captured by the image capturing unit 116. The dishing-up surface is, for example, a surface with a burnt mark in a case where the food material C is meat, fish, or the like. The selection unit 16 is electrically connected to the image capturing unit 116 of the robot 100. The selection unit 16 extracts a shape, a composition, and the like of the food material C from the image, and selects a surface of the food material C which looks good from the shape, the composition, and the like as the dishing-up surface. For example, the selection unit 16 compares the extracted shape, the composition, and the like with a database to select a surface that looks good as the dishing-up surface. The selection unit 16 outputs a selection result to the analysis unit 17.

The analysis unit 17 analyzes a surface state of the food material C on the basis of an image of the food material C during cooking, captured by the image capturing unit 116. The analysis unit 17 is electrically connected to the image capturing unit 116 of the robot 100. The analysis unit 17 analyzes a distribution of a color change (baked color) of the food material C. The analysis unit 17 analyzes a portion of the dishing-up surface of the food material C where the baked color is insufficient. The analysis unit 17 outputs an analysis result to the specifying unit 18. The analysis result includes, for example, information indicating a distribution of a color on the dishing-up surface of the food material C. Note that the analysis unit 17 may analyze a Maillard reaction of the food material by using an olfactory sensor or the like.

The specifying unit 18 specifies a cooking spot of the food material C during cooking on the basis of the analysis result of the analysis unit 17. The cooking spot includes, for example, a spot where the food material C needs to be heated, a spot where the baked color is insufficient, and the like. The specifying unit 18 specifies a spot where cooking is insufficient as the cooking spot in a case where the dishing-up surface of the food material C during cooking is made uniform. For example, the specifying unit 18 specifies a portion where the baked color is insufficient on the dishing-up surface of the food material C from the analysis result, and outputs a specifying result indicating the specified portion to the execution unit 15. In addition, in a case where the cooking of the food material C is completed, such that the cooking spot cannot be specified, the specifying unit 18 outputs an analysis result indicating such a situation to the execution unit 15.

The execution unit 15 executes processing based on the specifying result of the specifying unit 18. For example, the execution unit 15 executes processing for causing the drive unit 101 of the robot 100 to cook the cooking spot indicated by the specifying result. Then, the execution unit 15 causes the drive unit 101 of the robot 100 to perform cooking based on cooking data 12C of the food material C stored in the storage unit 12.

The cooking data 12C includes, for example, information indicating a relationship between a degree of heating of the cooking device 200 in a cooking method and a thickness of the food material C. In the present embodiment, the cooking data 12C includes information indicating a threshold value for a degree of heating of the food material C. For example, in a case where the cooking method is a baking method of steak, a degree of heating at a heating end timing differs depending on a thickness of meat. Then, it is assumed that the degree of heating is low heat in a case where the thickness of the meat is 2 cm or more and is the residual heat when the thickness of the meat is thinner than 2 cm. In this case, the threshold value for a degree of heating is set to 2 cm. In other words, the threshold value for a degree of heating is determined according to the cooking method, the thickness of the food material C, and heating power of the cooking device 200. The execution unit 15 can execute processing based on the thickness of the food material C during cooking.

[Processing Procedure of Information Processing Device 10 According to Second Embodiment]

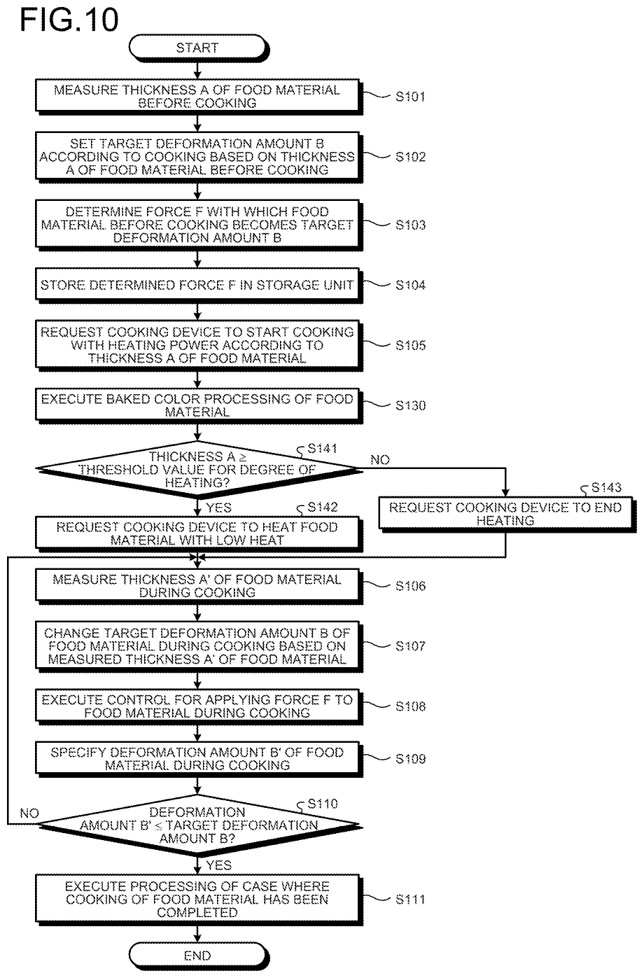

Next, an example of a processing procedure of the information processing device 10 according to the second embodiment will be described. FIG. 10 is a flowchart illustrating an example of a processing procedure executed by the information processing device 10 according to the second embodiment. The processing procedure illustrated in FIG. 10 is realized by the information processing device 10 executing a program. The processing procedure illustrated in FIG. 10 is repeatedly executed by the information processing device 10.

In the example illustrated in FIG. 10, Step S101 to Step S111 are the same as Step S101 to Step S111 illustrated in FIG. 6 described above, and thus, only different parts will be described and a description for the same parts will be omitted.

If the information processing device 10 requests the cooking device 200 to start the cooking with the heating power according to the thickness A of the food material C in Step S105, the information processing device 10 executes baked color processing of the food material C (Step S130). The baked color processing of the food material C is, for example, processing for selecting the dishing-up surface of the food material C and causing the robot 100 to cook the dishing-up surface. Details of the baked color processing will be described later. If the information processing device 10 causes the robot 100 to cook the dishing-up surface of the food material C, the information processing device 10 advances the processing to Step S141.

The information processing device 10 determines whether or not the thickness A of the food material C is equal to or greater than the threshold value for a degree of heating of the cooking data 12C (Step S141). In a case where the information processing device 10 has determined that the thickness A of the food material C is equal to or greater than the threshold value for a degree of heating (Step S141: Yes), the information processing device 10 advances the processing to Step S142. The information processing device 10 requests the cooking device 200 to heat the food material C with low heat via the communication unit 102 (Step S142). As a result, the cooking device 200 heats the food material C with low heat. Then, if the processing of Step S142 ends, the information processing device 10 advances the processing to Step S106 described above. Then, the information processing device 10 executes the processing from Step S106.

Alternatively, in a case where the information processing device 10 has determined that the thickness A of the food material C is not equal to or greater than the threshold value for a degree of heating (Step S141: No), the information processing device 10 advances the processing to Step S143. The information processing device 10 requests the cooking device 200 to end the heating via the communication unit 102 (Step S143). As a result, the cooking device 200 ends the heating. Then, if the processing of Step S143 ends, the information processing device 10 advances the processing to Step S106 described above. Then, the information processing device 10 executes the processing from Step S106.

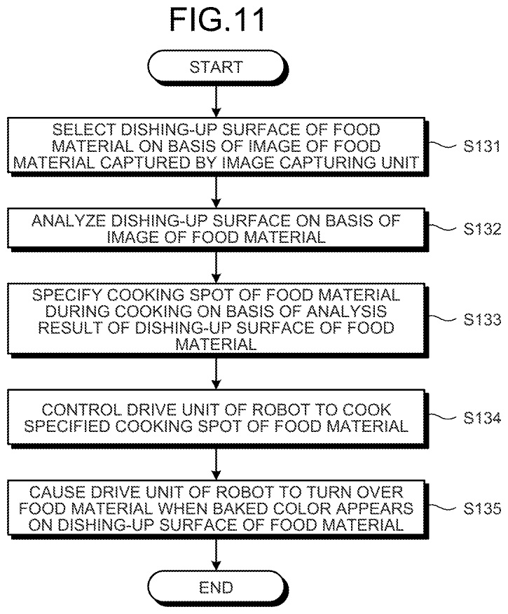

Next, an example of a processing procedure of the baked color processing of the food material C executed by the processing procedure illustrated in FIG. 10 will be described. FIG. 11 is a flowchart illustrating an example of a processing procedure of the baked color processing executed by the information processing device 10 according to the second embodiment. The processing procedure illustrated in FIG. 11 is realized by the information processing device 10 executing a program. The processing procedure illustrated in FIG. 11 is executed by the information processing device 10 according to the execution of the processing in Step S130 illustrated in FIG. 10.

As illustrated in FIG. 11, the information processing device 10 selects the dishing-up surface of the food material C on the basis of the image of the food material C captured by the image capturing unit 116 (Step S131). For example, the information processing device 10 extracts the shape, the composition, and the like of the food material C from the image, and selects the surface of the food material C which looks good from the shape, the composition, and the like as the dishing-up surface. The information processing device 10 realizes the selection unit 16 by executing Step S131. If the processing of Step S131 ends, the information processing device 10 advances the processing to Step S132.

The information processing device 10 analyzes the dishing-up surface on the basis of the image of the food material C (Step S132). For example, the information processing device 10 analyzes the distribution of the color change of the food material C and stores the analysis result in the storage unit 12. The information processing device 10 realizes the analysis unit 17 by executing Step S132. If the processing of Step S132 ends, the information processing device 10 advances the processing to Step S133.

The information processing device 10 specifies the cooking spot of the food material C during cooking on the basis of the analysis result of the dishing-up surface of the food material C (Step S133). For example, the information processing device 10 specifies a spot where the food material C is insufficient as the cooking spot. The information processing device 10 realizes the specifying unit 18 by executing Step S133. If the processing of Step S133 ends, the information processing device 10 advances the processing to Step S134.

The information processing device 10 causes the drive unit 101 of the robot 100 to cook the specified cooking spot of the food material C (Step S134). The information processing device 10 realizes the execution unit 15 by executing Step S134. As a result, the robot 100 cooks the specified cooking spot of the food material C. If the processing of Step S134 ends, the information processing device 10 advances the processing to Step S135.

The information processing device 10 causes the drive unit 101 of the robot 100 to turn over the food material C when the baked color appears on the dishing-up surface of the food material C (Step S135). For example, the information processing device 10 causes the drive unit 101 of the robot 100 to lift the food material C during cooking. Then, the information processing device 10 determines whether or not the baked color appears on the dishing-up surface on the basis of the image of the food material C captured by the image capturing unit116, and causes the drive unit 101 of the robot 100 to turn over the food material C if the baked color appears on the dishing-up surface. As a result, the robot 100 brings a surface opposite to the dishing-up surface of the food material C into contact with the cooking device 200. If the processing in Step S125 ends, the information processing device 10 ends the processing procedure illustrated in FIG. 11 and returns to the processing in Step S130 in FIG. 10.

As described above, the information processing device 10 according to the second embodiment can obtain actions and effects similar to those of the information processing device 10 according to the first embodiment.

In addition, the information processing device 10 according to the second embodiment selects the dishing-up surface of the food material C on the basis of the image of the food material C captured by the image capturing unit 116. Therefore, the information processing device 10 can estimate the progress of cooking of the food material C whose dishing-up surface has been selected. As a result, the information processing device 10 can improve estimation accuracy of the progress of the cooking including the selection of the dishing-up surface of the food material C.

In addition, the information processing device 10 analyzes the surface state of the food material C on the basis of the captured image of the food material C during cooking, and specifies the cooking spot of the food material C during cooking on the basis of the analysis result. Then, the information processing device 10 can execute the processing based on the specifying result, and can thus cause the drive unit 101 of the robot 100 to cook the specified cooking spot. As a result, the information processing device 10 can improve the estimation accuracy of the progress of the cooking and improve an appearance of the food material C after cooking.

[Hardware Configuration]

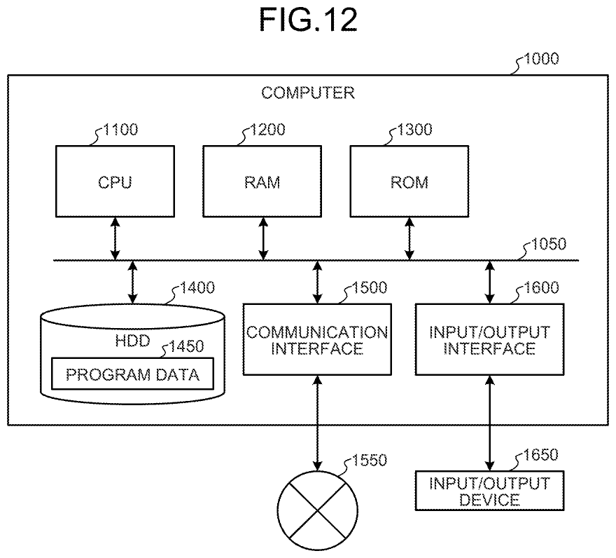

The information processing devices 10 according to the first and second embodiments described above are realized by, for example, a computer 1000 having a configuration as illustrated in FIG. 12. Hereinafter, the information processing device 10 according to the embodiment will be described as an example. FIG. 12 is a hardware configuration diagram illustrating an example of a computer 1000 that realizes a function of the information processing device 10. The computer 1000 includes a CPU 1100, a RAM 1200, a read only memory (ROM) 1300, a hard disk drive (HDD) 1400, a communication interface 1500, and an input/output interface 1600. Respective units of the computer 1000 are connected to each other by a bus 1050.

The CPU 1100 operates based on a program stored in the ROM 1300 or the HDD 1400, and controls each unit. For example, the CPU 1100 expands the program stored in the ROM 1300 or the HDD 1400 in the RAM 1200 to execute processing corresponding to various programs.

The ROM 1300 stores a boot program such as a basic input output system (BIOS) or the like executed by the CPU 1100 at the time of start-up of the computer 1000, a program dependent on hardware of the computer 1000, or the like.

The HDD 1400 is a computer-readable recording medium that non-temporarily records a program executed by the CPU 1100, data used by such a program, and the like. Specifically, the HDD 1400 is a recording medium that records an information processing program according to the present disclosure, which is an example of program data 1450.

The communication interface 1500 is an interface for connecting the computer 1000 to an external network 1550 (for example, the Internet). For example, the CPU 1100 receives data from another device or transmits data generated by the CPU 1100 to another device, via the communication interface 1500.

The input/output interface 1600 is an interface for connecting an input/output device 1650 and the computer 1000 to each other. For example, the CPU 1100 receives data from an input device such as a keyboard, a mouse, or the like via the input/output interface 1600. In addition, the CPU 1100 also transmits data to an output device such as a display, a speaker, a printer, or the like, via the input/output interface 1600. In addition, the input/output interface 1600 may function as a media interface that reads a program or the like recorded in a predetermined recording medium. The medium is, for example, an optical recording medium such as a digital versatile disc (DVD) or the like, a magneto-optical recording medium such as a magneto-optical disk (MO) or the like, a tape medium, a magnetic recording medium, a semiconductor memory, or the like.

For example, in a case where the computer 1000 functions as the information processing device 10 according to the embodiment, the CPU 1100 of the computer 1000 realizes functions of the measurement unit 11, the determination unit 13, the estimation unit 14, the execution unit 15, the selection unit 16, the analysis unit 17, the specifying unit 18, and the like, by executing the program loaded on the RAM 1200. In addition, the HDD 1400 stores the information processing program according to the present disclosure or the data in the storage unit 12. Note that the CPU 1100 reads and executes the program data 1450 from the HDD 1400, but as another example, these programs may be acquired from another device via the external network 1550.

A case in which the information processing device 10 estimates the progress of the cooking when the food material C is beef has been described in the first and second embodiments described above, but the present disclosure is not limited thereto. For example, the information processing device 10 may be configured to estimate the progress of cooking of fish, cooking of paste, cooking of powder, and the like.

In the information processing device 10, a case where the food material C is meat has been described in the first and second embodiments described above, but the present disclosure is not limited thereto. In the information processing device 10, for example, the food material C may be a material such as pasta, a raw noodle, or the like. In this case, the information processing device 10 is only required to estimate the progress of the cooking on the basis of a change amount between elasticity of the food material C before boiling and elasticity of the food material C after boiling. As a result, for example, even though a change occurs in the elasticity of the food material C due to temperature or humidity, the information processing device 10 can estimate the progress of the cooking without being affected by the change in the elasticity.

In addition, in the information processing device 10, for example, the food material C may be a material for producing roux, sauce, bean jam, or the like. In this case, the information processing device 10 is only required to estimate the progress of cooking on the basis of a change amount in a force for the food material C before and during cooking. For example, in the food material C, there is a case where changes in a state such as “liquid only”, “thermally unstable emulsion”, “suspension”, “colloidal liquid”, “sol→gel”, and the like, are observed in an initial state, during cooking, or in finish. In this case, the information processing device 10 sets a change amount in a force to be applied to the food material C according to a “viscosity” or a “type of relationship of a magnitude of a viscosity depending on a magnitude of a flow”. Then, the information processing device 10 can estimate the progress of cooking on the basis of a change amount in a force when the pressing portion is moved by the food materials C before cooking and during cooking.

In the first and second embodiments described above, the information processing device 10 may determine a target thickness of the food material C during cooking in a portion pressed with a set force on the basis of a thickness of the food material C before cooking in the portion pressed with the set force. Then, the information processing device 10 may estimate the progress of cooking of the food material on the basis of a comparison result between the thickness of the food material during cooking in the portion to which the pressing portion applies the set force and the target thickness. Note that the set force is, for example, a force set on the basis of a thickness, an elastic force, and the like of the food material C. Then, the information processing device 10 prepares, for example, a database, a calculation formula, and the like that derive a target thickness from the thickness of the food material C and the thickness of the food material C before cooking when pressed with the set force. For example, the information processing device 10 estimates that the cooking of the food material C has been completed in a case where the thickness of the food material C during cooking in the portion to which the set force is applied has reached the target thickness.

A case where the information processing device 10 is incorporated in the robot 100 has been described in the first and second embodiments described above, but the present disclosure is not limited thereto. The information processing device 10 may be incorporated into, for example, the cooking device, and may include a pressing portion and a driving mechanism that drives the pressing portion. The information processing device 10 may be configured as, for example, a dedicated device including a pressing portion and a driving mechanism for driving the pressing portion.

Hereinabove, the preferred embodiments of the present disclosure have been described in detail with reference to the accompanying drawings, but a technical scope of the present disclosure is not limited to such examples. It will be apparent to those skilled in the art of the present disclosure that various modifications or alterations can be conceived within the scope of the technical idea described in the claims, and it is naturally understood that these modifications or alterations also fall within the technical scope of the present disclosure.

Furthermore, the effects described in the present specification are merely illustrative or exemplary rather than being restrictive. That is, the technology according to the present disclosure can accomplish other effects apparent to those skilled in the art from the description of the present specification, in addition to or instead of the effects described above.

In addition, a program for causing hardware such as a CPU, a ROM, a RAM, and the like, built in a computer to exhibit the same functions as that of a configuration of the information processing device 10 can also be created, and a computer-readable recording medium on which the program is recorded can also be provided.

In addition the respective steps in the processing of the information processing device 10 of the present specification do not necessarily have to be processed in time series in the order described as the flowchart. For example, the respective steps in the processing of the information processing device 10 may be processed in the order different from the order described as the flowchart or may be processed in parallel with one another.

Note that the present technology can also have the following configuration.
(1)

An information processing device comprising:

a determination unit that determines a force to be applied to a food material during cooking by a pressing portion on the basis of food material information regarding elasticity of the food material before cooking; and

an estimation unit that estimates progress of cooking of the food material on the basis of information regarding deformation of the food material when the pressing portion has applied the force to the food material during the cooking.
(2)

The information processing device according to (1), wherein

the food material information includes information indicating a thickness of the food material before the cooking,

the determination unit determines a force that deforms the food material to a target deformation amount according to the thickness of the food material as the force, and

the estimation unit estimates that the cooking of the food material has been completed in a case where the deformation of the food material when the pressing portion has applied the force to the food material during the cooking has become the target deformation amount.
(3)

The information processing device according to (2), further comprising

a measurement unit that measures the thickness of the food material,

wherein the estimation unit changes the target deformation amount on the basis of the thickness of the food material during the cooking, measured by the measurement unit, and estimates that the cooking of the food material has been completed in a case where a deformation amount of the food material during the cooking has become the target deformation amount after the change.
(4)

The information processing device according to (2) or (3), wherein

the determination unit determines the force to be applied to the food material during the cooking on the basis of the force with which the pressing portion has deformed the food material before the cooking to the target deformation amount.
(5)

The information processing device according to any one of (1) to (4), wherein

the determination unit determines the force to be applied to the food material during the cooking on the basis of the food material information at a plurality of different measurement points in the food material before the cooking.
(6)

The information processing device according to any one of (1) to (5), wherein

the estimation unit estimates the progress of the cooking of the food material on the basis of an amount of juice accumulated in a dent of the food material during the cooking pressed with the force by the pressing portion.
(7)

The information processing device according to any one of (1) to (6), wherein

the food material is at least one of meat and fish, and

the cooking is cooking that cooks the food material.
(8)

The information processing device according to any one of (1) to (7), further comprising

an execution unit that executes processing based on an estimation result of the estimation unit.
(9)

The information processing device according to (8), in which

the execution unit executes the processing on the basis of the thickness of the food material during the cooking.
(10)

The information processing device according to (8) or (9), further comprising

a selection unit that selects a dishing-up surface of the food material on the basis of a captured image of the food material.
(11)

The information processing device according to any one of (8) to (10), further comprising:

an analysis unit that analyzes a surface state of the food material on the basis of a captured image of the food material during the cooking; and

a specifying unit that specifies a cooking spot of the food material during the cooking on the basis of an analysis result of the analysis unit, wherein

the execution unit executes processing based on a specifying result of the specifying unit.
(12)

The information processing device according to any one of (1) to (11), wherein

the determination unit determines the force of the pressing portion provided in a robot.
(13)

An information processing method executed by a computer, comprising:

determining a force to be applied to a food material during cooking by a pressing portion on the basis of food material information regarding elasticity of the food material before cooking; and

estimating progress of cooking of the food material on the basis of information regarding deformation of the food material when the pressing portion has applied the force to the food material during the cooking.
(14)

A program for causing a computer to execute:

a step of determining a force to be applied to a food material during cooking by a pressing portion on the basis of food material information regarding elasticity of the food material before cooking; and

a step of estimating progress of cooking of the food material on the basis of information regarding deformation of the food material when the pressing portion has applied the force to the food material during the cooking.
(15)

An information processing device including:

a determination unit that determines a target thickness of a food material during cooking in a portion pressed with a set force by a pressing portion on the basis of a thickness of the food material before cooking in the portion pressed with the set force by the pressing portion; and

an estimation unit that estimates progress of cooking of the food material on the basis of comparison result between a thickness of the food material during cooking in the portion to which the pressing portion applies the set force and the target thickness.

### REFERENCE SIGNS LIST

10 INFORMATION PROCESSING DEVICE

11 MEASUREMENT UNIT

12 STORAGE UNIT

12A FOOD MATERIAL DATA

12B ESTIMATION DATA

12C COOKING DATA

13 DETERMINATION UNIT

14 ESTIMATION UNIT

15 EXECUTION UNIT

16 SELECTION UNIT

17 ANALYSIS UNIT

18 SPECIFYING UNIT

100 ROBOT

110 ROBOT MAIN BODY

111 BASE PORTION

112 BODY PORTION

113 ARM

114 HEAD PORTION

115 MOVING MECHANISM

116 IMAGE CAPTURING UNIT

120 HAND

121 FINGER

121a PRESSURE DETECTION UNIT

122 POSITION GRASPING UNIT

C FOOD MATERIAL

1. An information processing device comprising:
a determination unit that determines a force to be applied to a food material during cooking by a pressing portion on the basis of food material information regarding elasticity of the food material before cooking; and
an estimation unit that estimates progress of cooking of the food material on the basis of information regarding deformation of the food material when the pressing portion has applied the force to the food material during the cooking.

2. The information processing device according to claim 1, wherein
the food material information includes information indicating a thickness of the food material before the cooking,
the determination unit determines a force that deforms the food material to a target deformation amount according to the thickness of the food material as the force, and
the estimation unit estimates that the cooking of the food material has been completed in a case where the deformation of the food material when the pressing portion has applied the force to the food material during the cooking has become the target deformation amount.

3. The information processing device according to claim 2, further comprising
a measurement unit that measures the thickness of the food material,
wherein the estimation unit changes the target deformation amount on the basis of the thickness of the food material during the cooking, measured by the measurement unit, and estimates that the cooking of the food material has been completed in a case where a deformation amount of the food material during the cooking has become the target deformation amount after the change.

4. The information processing device according to claim 2, wherein
the determination unit determines the force to be applied to the food material during the cooking on the basis of the force with which the pressing portion has deformed the food material before the cooking to the target deformation amount.

5. The information processing device according to claim 1, wherein
the determination unit determines the force to be applied to the food material during the cooking on the basis of the food material information at a plurality of different measurement points in the food material before the cooking.

6. The information processing device according to claim 1, wherein
the estimation unit estimates the progress of the cooking of the food material on the basis of an amount of juice accumulated in a dent of the food material during the cooking pressed with the force by the pressing portion.

7. The information processing device according to claim 1, wherein
the food material is at least one of meat and fish, and
the cooking is cooking that cooks the food material.

8. The information processing device according to claim 1, further comprising
an execution unit that executes processing based on an estimation result of the estimation unit.

9. The information processing device according to claim 8, further comprising
a selection unit that selects a dishing-up surface of the food material on the basis of a captured image of the food material.

10. The information processing device according to claim 8, further comprising:
an analysis unit that analyzes a surface state of the food material on the basis of a captured image of the food material during the cooking; and
a specifying unit that specifies a cooking spot of the food material during the cooking on the basis of an analysis result of the analysis unit, wherein
the execution unit executes processing based on a specifying result of the specifying unit.

11. The information processing device according to claim 1, wherein
the determination unit determines the force of the pressing portion provided in a robot.

12. An information processing method executed by a computer, comprising:
determining a force to be applied to a food material during cooking by a pressing portion on the basis of food material information regarding elasticity of the food material before cooking; and
estimating progress of cooking of the food material on the basis of information regarding deformation of the food material when the pressing portion has applied the force to the food material during the cooking.

13. A program for causing a computer to execute:
a step of determining a force to be applied to a food material during cooking by a pressing portion on the basis of food material information regarding elasticity of the food material before cooking; and
a step of estimating progress of cooking of the food material on the basis of information regarding deformation of the food material when the pressing portion has applied the force to the food material during the cooking.
